(19) United States
(12) Patent Application Publication
(10) Pub. No.: US 2025/0364566 A1
(43) Pub. Date: Nov. 27, 2025

(54) HIGH-PERFORMANCE SILICON-BASED COMPOSITE ANODE MATERIALS COATED WITH CONDUCTIVE POLYMER AND GRAPHENE OR REDUCED GRAPHENE OXIDE AND METHOD OF MANUFACTURING THE SAME

(71) Applicants: KAIROS Co., Ltd., Jecheon-si (KR); JNC Materials Co., Ltd., Jecheon-si (KR)

(72) Inventors: Byung-Chul LEE, Anyang-si (KR); Sung-Sik WON, Ulsan (KR); Chang-Kun LEE, Seoul (KR); Kyung Won CHUNG, Seongnam-si (KR)

(21) Appl. No.: 19/216,315

(22) Filed: May 22, 2025

(30) Foreign Application Priority Data
May 23, 2024 (KR) 10-2024-0066901

(51) Int. Cl. H01M 4/62; C01B 33/02; H01M 4/36; H01M 4/38; H01M 4/587

(52) U.S. Cl. CPC H01M 4/628; C01B 33/02; H01M 4/366; H01M 4/386; H01M 4/587; H01M 4/622; C01P 2004/04; C01P 2004/61; C01P 2004/80; C01P 2006/40; C01P 2006/80

(57) ABSTRACT

Provided are a high-performance silicon-based composite anode material coated with a conductive polymer and graphene or reduced graphene oxide capable of exhibiting expansion suppression high-performance such as high capacity, high-efficiency, fast charging, and high-stability by coating a silicon-based powder with a conductive polymer, followed by coating with graphene or reduced graphene oxide or by simultaneously coating a silicon-based powder with a conductive polymer and graphene or reduced graphene oxide to increase adhesion of graphene and stability of silicon, for the purpose of stable formation of a composite of the silicon-base powder and expansion suppression during charging and discharging, and a method of manufacturing the same.

### CROSS-REFERENCE TO RELATED APPLICATION(S)

This application claims priority to and the benefit of Korean Patent Application No. 10-2024-0066901, filed on May 23, 2024 in the Korean Intellectual Property Office, the disclosure of which is incorporated herein by reference in its entirety.

### BACKGROUND

### 1. Field

The present disclosure relates to a high-performance silicon-based composite anode material coated with a conductive polymer and graphene or reduced graphene oxide, and a method of manufacturing the same, and more particularly, to a high-performance silicon-based composite anode material coated with a conductive polymer and graphene or reduced graphene oxide capable of exhibiting expansion suppression high-performance such as high capacity, high-efficiency, fast charging, and high-stability by coating a silicon-based powder with a conductive polymer, followed by coating with graphene or reduced graphene oxide or by simultaneously coating a silicon-based powder with a conductive polymer and graphene or reduced graphene oxide to increase adhesion of graphene and stability of silicon, for the purpose of stable formation of a composite of the silicon-base powder and expansion suppression during charging and discharging, and a method of manufacturing the same.

### 2. Description of Related Art

In accordance with an increase in social demand for portable electronic devices, power tools, and electric vehicles, the necessity for high-performance secondary batteries has increased. In particular, in accordance with the emergence of electric vehicles, fast-charging lithium-ion batteries with a high electric capacity and a low weight have been necessarily required.

Currently, a commercially available graphite-based powder is a main raw material for an anode material of a lithium-ion battery, but may not satisfy essential requirements in a battery market requiring a high capacity and high performance because a maximum capacity is low and a charge and discharge rate is slow. Therefore, there is an urgent need to develop a new anode material that meets these requirements.

When a silicon-based anode material whose capacity per unit weight is 10 times or more than that of an existing graphite anode material is used instead of an existing graphite-based material used as an anode material in order to expand the charge capacity of the secondary battery and perform high-speed charging of the secondary battery, a thickness of an electrode may be reduced, and a greater amount of lithium ions may be more rapidly stored and discharged. As a result, when the silicon anode material is used, it is possible to increase a driving range and a charging speed. Thus, recently, research into an attempt to apply the silicon-based anode material instead of the existing graphite-based anode material and the addition and use of silicon to the existing graphite-based anode material has been competitively conducted domestically and internationally.

However, in the case of the silicon anode material, lithium and silicon react with each other during the movement of lithium from a cathode to an anode. In this case, a volume expansion of approximately 400% occurs, which causes crack phenomenon of a silicon powder, and as charging and discharging are repeated, the silicon powder is pulverized. Accordingly, structural deformation of the electrode occurs, such that a function of the electrode is lost, or consumption of more lithium ions is required due to delamination of a solid electrolyte interphase (SEI) and the formation of a heterogeneous interface, resulting in a significantly decrease in efficiency.

As a result, performance degradation (decrease in initial energy capacity when charging and discharging are repeated) and a lifespan reduction phenomenon of the lithium-ion battery are severe, and thus, practical commercialization of the lithium-ion battery has been delayed.

Attempts to solve such a problem using nanostructured silicon such as a nanopowder, a nanowire, and various nanoporous bodies have been currently made. However, most methods of manufacturing nanostructured silicon are incompatible with an existing method of manufacturing a battery and have used expensive high-temperature chemical vapor deposition (CHD) that may not increase a scale for mass production or a complex series of chemical reactions, templates, or the like. In addition, a cost of a nano-raw material is approximately 10 times more than that of micron-sized silicon, and it is thus difficult to apply the method of manufacturing nanostructured silicon in practice.

Currently, as a method of using a silicon-based material, a Six composite oxide, SiC, or a silicon alloy has been used. However, since the SiOx composite oxide, SiC, or the silicon alloy has low electrical conductivity due to low initial capacity, non-uniformity, and insulating properties, a degradation of electrochemical performance occurs and a material cost is excessively high. As another method, there has been an attempt to increase stability and capacity by adding a small amount of silicon to the existing graphite-based anode material, but an amount of added silicon is limited to 10 wt % or less and a process cost is high, which makes commercialization difficult.

Recently, a method of coating or surrounding silicon with graphene to mitigate volume expansion and increase conductivity has attracted attention. However, since adhesion between graphene and silicon is low, an actual effect is slight due to detachment of graphene and silicon as charging and discharging are performed.

In addition, all solutions currently proposed exhibit an effect only when they are applied to expensive nano-silicon powders that have a size of approximately 100 nm or less and have a uniform shape, and there are no cases where these solutions are successful when they are applied to relatively inexpensive micron-sized silicon that has an irregular shape.

As Related Art Document, there is Korean Patent Laid-Open Publication No. 10-2023-0154397 (published on Nov. 8, 2023), which discloses a nano-silicon aggregate composite negative electrode material and a preparation method therefor.

### SUMMARY

An object of the present disclosure is to provide a high-performance silicon-based composite anode material coated with a conductive polymer and graphene or reduced graphene oxide capable of exhibiting expansion suppression high-performance such as high capacity, high-efficiency, fast charging, and high-stability by coating a silicon-based powder with a conductive polymer, followed by coating with graphene or reduced graphene oxide or by simultaneously coating a silicon-based powder with a conductive polymer and graphene or reduced graphene oxide to increase adhesion of graphene and stability of silicon, for the purpose of stable formation of a composite of the silicon-base powder and expansion suppression during charging and discharging, and a method of manufacturing the same.

A method of manufacturing a high-performance silicon-based composite anode material coated with a conductive polymer and graphene or reduced graphene oxide according to an embodiment of the present disclosure to achieve the above object include: a surface treatment step of surface-treating silicon-based powder; a composite solution preparation step of preparing a silicon-based composite solution by coating the surface-treated silicon-based powder with a conductive polymer and then compositing the surface-treated silicon-based powder with graphene or reduced the graphene oxide or by simultaneously compositing surface-treated silicon-based powder with the conductive polymer and the graphene or the reduced graphene oxide; and a composite powder manufacturing step of manufacturing r a silicon-based composite anode material by washing, filtering, and drying the silicon-based composite solution.

The surface treatment step includes a surface modification process for forming a hydroxy radical on a surface of the silicon-based powder.

The silicon-based powder includes one or more selected from the group consisting of from pure Si, SiOx (0.5≤x≤1.5), SiC, and a Si alloy having an average diameter of 1 nm to 100 μm.

The conductive polymer includes one or more selected from the group consisting of polypyrrole, polythiophene, polyacetylene, polyaniline, poly(3,4-ethylenedioxythiophene) (PEDOT:PSS), poly(p-phenylene), and poly(p-phenylene vinylene).

The graphene is graphene or reduced graphene oxide having 1 to 6 layers and an average diameter of 1 to 10 μm.

In the composite solution preparation, the conductive polymer is added to the surface-treated silicon-based powder solution in distilled water, and then stirred to react to prepare a silicon-based powder-conductive polymer composite solution, and the graphene or the reduced graphene oxide is then mixed with the silicon-based powder-conductive polymer composite solution and reacted.

In the composite solution preparation, the conductive polymer and the graphene or the reduced graphene oxide are simultaneously added to the surface-treated silicon-based powder solution in distilled water, stirred, and reacted.

In the filtering, washing, and drying, a structure stably surrounding a surface of the silicon-based powder is formed by filtering the silicon-based powder-conductive polymer-graphene composite solution to remove a solvent, washing the silicon-based composite powder with purified distilled water to remove impurities, excess ions, and oligomers adsorbed on the surface of the silicon-based composite powder, and removing residual moisture through a drying process to coat the surface of the silicon-based powder with the conductive polymer and the graphene or the reduced graphene oxide

The silicon-based composite powder includes a silicon-based powder located at an inner center, graphene or reduced graphene oxide coated to surround an outer side of the silicon-based powder, and a conductive polymer disposed in a space between the silicon-based powder and the graphene or the reduced graphene oxide and coated to surround the silicon-based powder.

The silicon-based composite powder includes a silicon-based powder located at an inner center, and a mixed composite coated to surround an outer side of the silicon-based powder, wherein the mixed composite includes a conductive polymer and graphene, and the graphene is graphene or reduced graphene oxide having 1 to 6 layers and an average diameter of 1 to 10 μm.

A high-performance silicon-based composite anode material coated with a conductive polymer and graphene or reduced graphene oxide according to an embodiment of the present disclosure to achieve the above object comprises: a silicon-based powder located in an inner center; graphene or reduced graphene oxide coated to surround an outer side of the silicon-based powder; and a conductive polymer disposed in a space between the silicon-based powder and the graphene or the reduced graphene oxide and coated to surround the silicon-based powder.

A high-performance silicon-based composite anode material coated with a conductive polymer and graphene or reduced graphene oxide according to the another embodiment of the present disclosure to achieve the above object comprises: a silicon-based powder located in an inner center; and a mixed composite coated to surround an outer side of the silicon-based powder, wherein the mixed composite includes a conductive polymer and graphene, and the graphene is graphene or reduced graphene oxide having 1 to 6 layers and an average diameter of 1 to 10 μm.

### BRIEF DESCRIPTION OF DRAWINGS

FIG. 1 is a process flow diagram illustrating a method of manufacturing a high-performance silicon-based composite anode material coated with a conductive polymer and graphene or reduced graphene oxide, according to embodiments of the present disclosure.

FIG. 2 is a process schematic diagram illustrating a method of manufacturing a high-performance silicon-based composite anode material coated with a conductive polymer and graphene or reduced graphene oxide, according to an embodiment of the present disclosure.

FIG. 3 is a schematic diagram illustrating a high-performance silicon-based composite anode material coated with a conductive polymer and graphene or reduced graphene oxide manufactured by the method according to an embodiment of the present disclosure.

FIG. 4 is a transmission electron microscopy (TEM) photograph illustrating the state of a silicon-based composite anode material manufactured according to Example 1 before charging and discharging.

FIGS. 5A and 5B are transmission electron microscopy (TEM) photographs illustrating the state of a silicon-based composite anode material manufactured according to Example 1 after charging and discharging.

FIG. 6 is a graph illustrating the results of measuring the charge/discharge capacity cycle characteristics of a half-coin cell using pure silicon powder according to Comparative Example 1 as the silicon-based anode material, and a half-coin cell using a composite powder of silicon powder-conductive polymer-graphene according to Example 1 as the silicon-based composite anode material.

### DETAILED DESCRIPTION

The advantages and features of the present disclosure, and methods of achieving them, will become apparent with reference to the embodiments described in detail below in conjunction with the accompanying drawings. However, the present disclosure is not limited to the embodiments disclosed below, and it will be implemented in various forms. Rather, these embodiments are provided so that the present disclosure is complete and fully conveys the scope of the present disclosure to those skilled in the art to which the present disclosure pertains. The present disclosure is defined solely by the scope of the claims. Throughout the specification, the same reference numbers refer to identical components.

Referring now to the accompanying drawings, a high-performance silicon-based composite anode material coated with a conductive polymer and graphene or reduced graphene oxides according to a preferred embodiment of the present disclosure and a method of manufacturing the same, will be described in detail as follows.

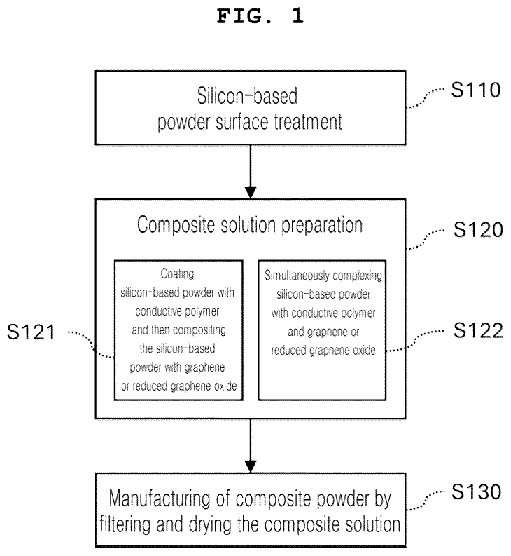

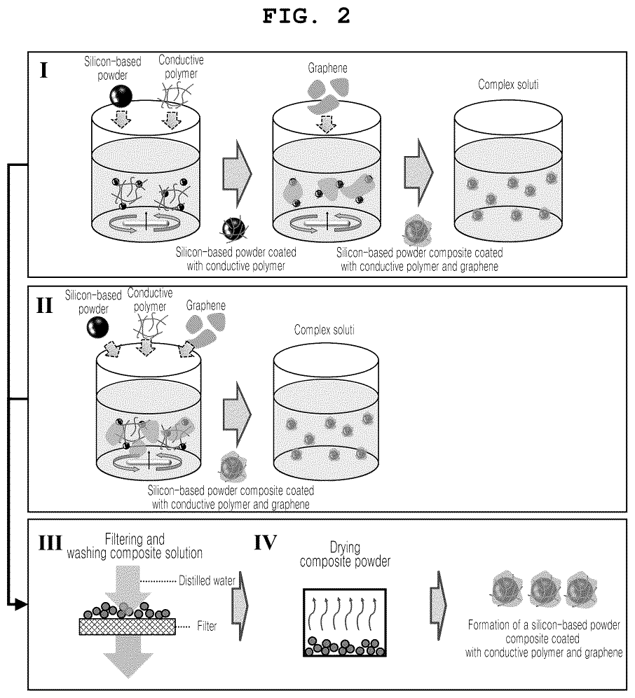

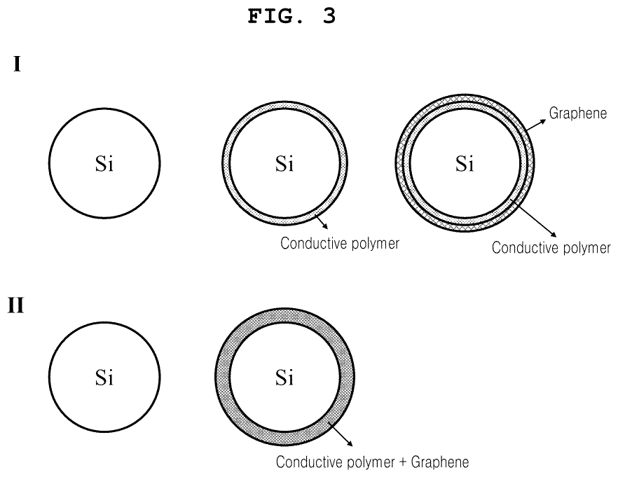

FIG. 1 is a process flow diagram illustrating a method of manufacturing a high-performance silicon-based composite anode material coated with a conductive polymer and graphene or reduced graphene oxide, according to embodiments of the present disclosure. FIG. 2 is a process schematic diagram illustrating a method of manufacturing a high-performance silicon-based composite anode material coated with a conductive polymer and graphene or reduced graphene oxide, according to an embodiment of the present disclosure. FIG. 3 is a schematic diagram illustrating a high-performance silicon-based composite anode material coated with a conductive polymer and graphene or reduced graphene oxide manufactured by the method according to an embodiment of the present disclosure.

Referring to FIGS. 1 to 3, the method of manufacturing a high-performance silicon-based composite anode material coated with a conductive polymer and graphene or reduced graphene oxide according to an embodiment of the present disclosure includes a silicon-based powder surface treatment step (S110), a composite solution preparation step (S120), and a composite powder manufacturing step (S130).

### Silicon-Based Powder Surface Treatment

In the silicon-based powder surface treatment step (S110), silicon-based powder is surface-treated.

Here, the silicon-based powder includes one or more selected from the group consisting of pure Si, SiOx (0.5≤x≤1.5), SiC, and a Si alloy having an average diameter of 1 nm to 100 μm.

It is preferable to use silicon-based powder having an average diameter of 1 nm to 100 μm, more preferably 100 nm to 50 μm, and most preferably 1 to 30 μm. If the average diameter of the silicon-based powder is less than 1 nm, there is a problem that a sufficient amount of lithium-ion charging and discharging cannot be achieved. Conversely, if the average grain diameter of the silicon-based powder exceeds 100 μm, there is a concern that the silicon-based powder may be easily broken by continuous lithium-ion charging and discharging, which is not preferable.

In this silicon-based powder surface treatment step (S110), surface treatment is performed to form a hydroxyl radical (—OH) on the surface of the silicon-based powder in order to uniformly coat the silicon-based powder with a conductive polymer and to increase adhesion between the silicon-based powder, the conductive polymer, and graphene.

As described above, the silicon-based powder surface treatment step (S110) includes a surface modification process for forming a hydroxy radical on a surface of the silicon-based powder.

This silicon-based powder surface treatment step (S110) will be described in more detail as follows.

First, the silicon-based powder is weighed, mixed with distilled water, and stirred in a stirrer. Next, reagents that act as reaction additives (dopants) and cross-linkers, such as phytic acid or formic acid, which can form hydroxy groups on the surface of the silicon-based powder, are weighted, added, and stirred. Then, to increase the conductivity of the conductive polymer, a small amount of an initiator or a partial oxidant is added, followed by mixing and stirring.

### Composite Solution Preparation

In the composite solution preparation step (S120), a silicon-based composite solution is prepared by coating the surface-treated silicon-based powder with a conductive polymer and then compositing the surface-treated silicon-based powder with graphene or reduced graphene oxide or by simultaneously compositing the surface-treated silicon-based powder with the conductive polymer and the graphene or the reduced graphene oxide.

In this composite solution preparation step (S120), it is preferable that the surface-treated silicon-based powder and graphene or reduced graphene oxide are weighed according to a mixing ratio, and then mixed and stirred.

Here, the conductive polymer includes one or more selected from the group consisting of polypyrrole, polythiophene, polyacetylene, polyaniline, (PEDOT:PSS), poly(3,4-ethylenedioxythiophene) poly(p-phenylene), and poly(p-phenylene vinylene).

In this step, it is preferable to perform stirring at a speed of 200 to 600 rpm, and more preferably at a speed of 300 to 500 rpm. If the stirring speed is less than 200 rpm, there is a concern that uniform mixing may not be achieved due to viscosity imbalance between the silicon-based powder, the conductive polymer, and graphene. Conversely, high-speed stirring exceeding 600 rpm may actually degrade uniformity, so caution is required.

In this composite solution preparation (S121), the conductive polymer may be added to the surface-treated silicon-based powder solution in distilled water, and then stirred to react to prepare a silicon-based powder-conductive polymer composite solution, and the graphene or the reduced graphene oxide may be then mixed with the silicon-based powder-conductive polymer composite solution and reacted.

In contrast, in the composite solution preparation (S122), the conductive polymer and the graphene or the reduced graphene oxide may be simultaneously added to the surface-treated silicon-based powder solution in distilled water, stirred, and reacted.

### Composite Powder Manufacturing

In the composite powder manufacturing step (S130), the silicon-based composite solution is washed, filtered, and dried to manufacture a silicon-based composite anode material.

In this step, in the filtering, washing, and drying, a structure stably surrounding a surface of the silicon-based powder is formed by filtering the silicon-based powder-conductive polymer-graphene composite solution to remove a solvent, washing the silicon-based composite powder with purified distilled water to remove impurities, excess ions, and oligomers adsorbed on the surface of the silicon-based composite powder, and removing residual moisture through a drying process to coat the surface of the silicon-based powder with the conductive polymer and the graphene or the reduced graphene oxide.

It is preferable perform the drying at 60 to 120° C. for 3 to 12 hours, and more preferably at 80 to 100° C. for 5 to 10 hours. If the drying temperature is less than 60° C. or the drying time is less than 3 hours, there is a concern that residual moisture may not be completely removed. Conversely, if the drying temperature exceeds 120° C. or the drying time exceeds 12 hours, it can act as a factor that only consumes excessive thermal energy and time, which is uneconomical.

In this step, the silicon-based composite powder may include a silicon-based powder located at an inner center, graphene or reduced graphene oxide coated to surround an outer side of the silicon-based powder, and a conductive polymer disposed in a space between the silicon-based powder and the graphene or the reduced graphene oxide and coated to surround the silicon-based powder.

In this case, it is preferable to form the conductive polymer as a layer having a thickness of 10 nm to 1 μm, and more preferably, a thickness 30 to 500 nm depending on the size of the silicon-based powder. If the layer thickness of the conductive polymer is less than 10 nm, it is difficult to properly exhibit the effect of improving conductivity. Conversely, if the layer thickness of the conductive polymer exceeds 1 μm, there are concerns that the uniformity of the coating may be degraded, in addition to the problem of longer processing times, rather than the advantage of additional property improvement.

Additionally, it is preferable to form the graphene or reduced graphene oxide as a layer having a thickness of 1 to 100 nm, and more preferably a thickness of 5 to 50 nm. If the layer thickness of the graphene or the reduced graphene oxide is less than 1 nm, there is a concern that it may not properly exhibit the effect of suppressing volume expansion of the silicon-based composite anode material due to charging and discharging. Conversely, if the layer thickness of the graphene or the reduced graphene oxide exceeds 100 nm, there is a concern that adhesion between the silicon-based powder, the conductive polymer, and the graphene may be degraded.

In contrast, the silicon-based composite powder includes a silicon-based powder located at an inner center, and a mixed composite coated to surround an outer side of the silicon-based powder, wherein the mixed composite may include a conductive polymer and graphene, and the graphene may be graphene or reduced graphene oxide having 1 to 6 layers and an average diameter of 1 to 10 μm.

In this case, it is preferable to form the mixed composite as a layer having a thickness of 10 nm to 1 μm, and more preferably, a thickness of 30 to 500 nm. If the layer thickness of the mixed composite is less than 10 nm, there is a concern that it may not properly exhibit the effect of suppressing volume expansion of the silicon-based composite anode material due to charging and discharging. Conversely, if the layer thickness of the mixed composite exceeds 1 μm, there are concerns that the uniformity of the coating may be degraded, in addition to the problem of longer processing times, rather than the advantage of additional property improvement.

As described above, the silicon-based composite anode material coated with the conductive polymer and the graphene or the reduced graphene oxide exhibit excellent adhesion between materials, suppresses the expansion of the silicon powder during charging and discharging, maintains the electrode characteristics even during the pulverization of the silicon powder, and has an excellent effect as the anode material regardless of the size of the shape of the silicon-based powder. Therefore, when the silicon-based composite anode material coated with the conductive polymer and the graphene or the reduced graphene oxide is applied to the secondary battery, it exhibits high capacity, fast charging, and stable charge/discharge cycle characteristics.

In addition, the method according to the present disclosure is simple, compatible for existing battery processes, and capable of mass production at a low production cost. Thus, by providing a method of manufacturing ideal high-performance anode materials, it is expected to have a significant effect on the development and commercialization of the battery industry.

As demonstrated above, with the high-performance silicon-based composite anode material coated with a conductive polymer and graphene or reduced graphene oxide and the method of manufacturing the same according to an embodiment of the present disclosure, a surface of a silicon-based powder are formed to have a structure in which it is coated and surrounded with a conductive polymer and graphene or reduced graphene oxide, such that it is possible to increase conductivity of the silicon-based composite anode material, increase the adhesion of graphene, exhibit a maximum suppression effect on volume expansion of the silicon-based composite anode material due to charging and discharging, and maintain electrode characteristics in spite of a pulverization phenomenon of the silicon-based powder.

As a result, the high-performance silicon-based composite anode material coated with a conductive polymer and graphene or reduced graphene oxide and the method of manufacturing the same according to an embodiment of the present disclosure can not only induce long-term stability of the battery, but also maximize an effect even when the silicon-based powder has a micron size as well as a nanosize or when the silicon-based powder has an irregular shape rather than a spherical shape.

As described above, the high-performance silicon-based composite anode material coated with a conductive polymer and graphene or reduced graphene oxide and the method of manufacturing the same according to an embodiment of the present disclosure can induce long-term stability of the battery by increasing the conductivity of the silicon-based composite anode material, suppressing the volume expansion of the silicon-based composite anode material due to charging and discharging, and maintaining the electrode characteristics in spite of the pulverization of the silicon-based powder, and can completely replace an existing graphite-based anode material having disadvantages such as low capacity and slow charging and a current nano-silicon anode material having a difficulty in mass production and applicability due to a high cost by maximizing an effect of the high-capacity silicon-based composite anode material regardless of a size or a shape of the silicon-based powder.

As a result, the high-performance silicon-based composite anode material coated with a conductive polymer and graphene or reduced graphene oxide and the method of manufacturing the same according to an embodiment of the present disclosure can be easily applied to an anode of a high-performance secondary battery by providing an ideal silicon-based composite anode material with high capacity, high efficiency, fast charging, and high stability, and can thus greatly contribute to development and commercialization of a battery industry.

### EXAMPLE

Hereinafter, the configuration and operation of the present disclosure will be described in more detail with reference to a preferred embodiment of the present disclosure. However, it should be understood that these examples are presented for illustrative purposes only and are not to be construed as limiting the scope of the present disclosure in any way.

The contents not described herein can be sufficiently inferred technically by those skilled in the art, and thus their description will be omitted.

### 1. Sample Preparation

### Example 1

30 g of pure silicon powder with a purity (>99%) and a particle size (D₅₀=2 μm) was mixed in 100 ml of distilled water, and the mixture was stirred at a stirring speed of 500 rpm.

Next, 10 g of phytic acid was further added, and the mixture was stirred at a speed of 500 rpm.

Subsequently, 3 g of aniline, a conductive polymer, was added to the stirred mixed solution, and then 0.5 g of ammonium persulphate was added to initiate a reaction.

Then, 0.9 g of graphene powder was further added, followed by a coating process at a stirring speed of 400 rpm to prepare the complex solution.

Next, the composite solution was washed with distilled water and filtered using a 5 μm qualitative filter paper to remove the solvents and impurities, and then dried in a drying oven at 110° C. for 7 hours to prepare a powder-form silicon-based composite anode material in which the surface of the silicon powder was sequentially coated with a conductive polymer and graphene.

### Comparative Example 1

Pure silicon powder with a purity (>99%) and a particle size (D₅₀=2 μm) was prepared.

### 2. Microstructure Observation

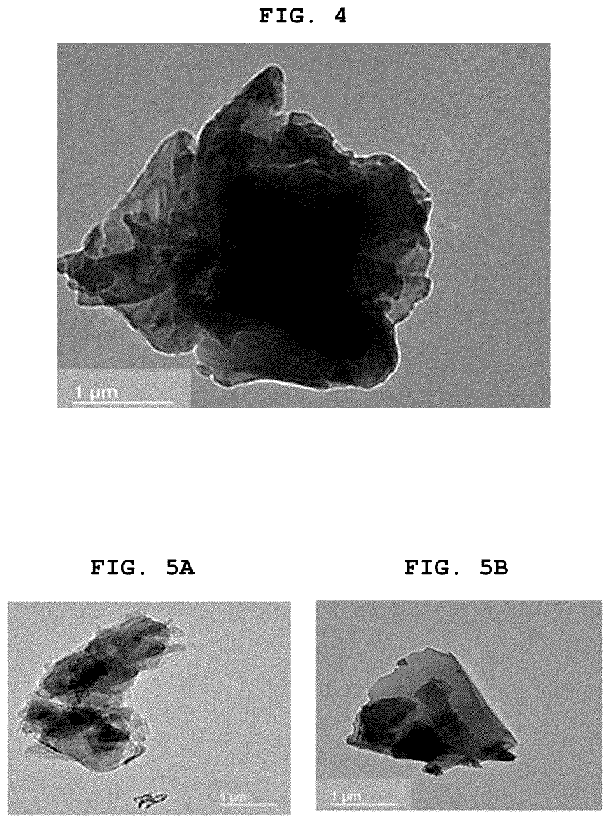

FIG. 4 is a transmission electron microscopy (TEM) photograph illustrating the state of a silicon-based composite anode material manufactured according to Example 1 before charging and discharging. FIGS. 5A and 5B are transmission electron microscopy (TEM) photographs illustrating the state of a silicon-based composite anode material manufactured according to Example 1 after charging and discharging.

As illustrated in FIGS. 4, 5A, and 5B, as the results of measuring the silicon-based composite anode material manufactured according to Example 1 using a transmission electron microscopy, it can be confirmed that even with silicon pulverization, the conductive polymer and graphene, which were coated without losing their coating structure, well surrounded and protected the silicon powder. As described above, it can be confirmed that the silicon-based composite anode material manufactured according to Example 1 have a structure in which the silicon powder is coated with a conductive polymer and graphene, uniformly surrounding the silicon powder.

### 3. Electrochemical Properties Evaluation

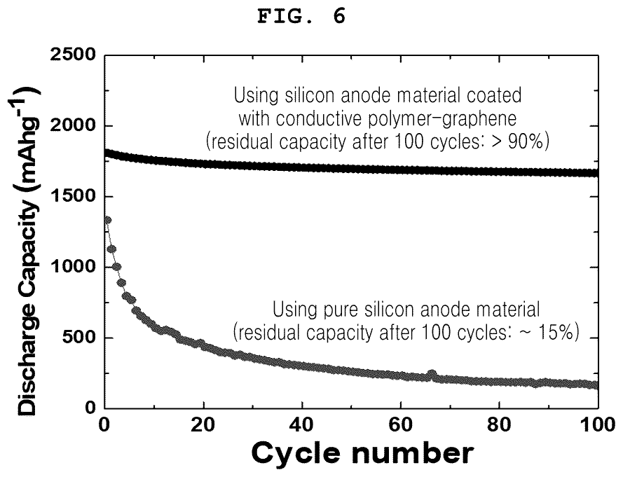

FIG. 6 is a graph illustrating the results of measuring the charge/discharge capacity cycle characteristics of a half-coin cell using pure silicon powder according to Comparative Example 1 as the silicon-based anode material, and a half-coin cell using a composite powder of silicon powder-conductive polymer-graphene according to Example 1 as the silicon-based composite anode material.

As illustrated in FIG. 6, it can be confirmed that after 100 charge/discharge cycles, the residual capacity was only about 15% when using the pure silicon powder according to Comparative Example 1, which was not coated, as the silicon-based anode material.

On the other hand, it can be confirmed that when using the composite powder of silicon powder-conductive polymer-graphene according to Example 1, in which the conductive polymer and graphene are uniformly coated, as the silicon-based composite anode material, the residual capacity was maintained at 90% or more with a high capacity of 1600 mAh/g or more even after 100 charge/discharge cycles.

As can be seen from the above experimental results, it was confirmed that the use of the product of the present disclosure enables the manufacture of a high-performance secondary battery anode material capable of maintaining stable cycle life characteristics with high capacity, and that the manufacturing method allow for a series of uniform coating through a simple mixing reaction process, thereby facilitating mass production and the manufacture of high-performance anodes for secondary batteries at reduced costs, ultimately securing mass productivity and commercialization potential.

With the high-performance silicon-based composite anode material coated with a conductive polymer and graphene or reduced graphene oxide and the method of manufacturing the same according to the present disclosure, a surface of a silicon-based powder are formed to have a structure in which it is coated and surrounded with a conductive polymer and graphene or reduced graphene oxide, such that it is possible to increase conductivity of the silicon-based composite anode material, increase the adhesion of graphene, exhibit a maximum suppression effect on volume expansion of the silicon-based composite anode material due to charging and discharging, and maintain electrode characteristics in spite of a pulverization phenomenon of the silicon-based powder.

As a result, the high-performance silicon-based composite anode material coated with a conductive polymer and graphene or reduced graphene oxide and the method of manufacturing the same according to the present disclosure can not only induce long-term stability of the battery, but also maximize an effect even when the silicon-based powder has a micron size as well as a nanosize or when the silicon-based powder has an irregular shape rather than a spherical shape.

As described above, the high-performance silicon-based composite anode material coated with a conductive polymer and graphene or reduced graphene oxide and the method of manufacturing the same according to the present disclosure can induce long-term stability of the battery by increasing the conductivity of the silicon-based composite anode material, suppressing the volume expansion of the silicon-based composite anode material due to charging and discharging, and maintaining the electrode characteristics in spite of the pulverization of the silicon-based powder, and can completely replace an existing graphite-based anode material having disadvantages such as low capacity and slow charging and a current nano-silicon anode material having a difficulty in mass production and applicability due to a high cost by maximizing an effect of the high-capacity silicon-based composite anode material regardless of a size or a shape of the silicon-based powder.

As a result, the high-performance silicon-based composite anode material coated with a conductive polymer and graphene or reduced graphene oxide and the method of manufacturing the same according to the present disclosure can be easily applied to an anode of a high-performance secondary battery by providing an ideal silicon-based composite anode material with high capacity, high efficiency, fast charging, and high stability, and can thus greatly contribute to development and commercialization of a battery industry.

While embodiments of the present disclosure have been mainly described hereinabove, various modifications and alterations may be made by those skilled in the art to which the present disclosure pertains. Such modifications and alterations may be considered to fall within the present disclosure without departing from the technical spirit of the present disclosure. Therefore, the scope of the present disclosure should be determined by claims described below.

### DETAIL DESCRIPTION OF MAIN ELEMENTS

S110: Silicon-based powder surface treatment step
S120: Composite solution preparation step
S130: Composite powder manufacturing step

What is claimed is:

1. A method of manufacturing a high-performance silicon-based composite anode material coated with a conductive polymer and graphene or reduced graphene oxide, the method comprising:
a surface treatment step of surface-treating silicon-based powder;
a composite solution preparation step of preparing a silicon-based composite solution coating the surface-treated silicon-based powder with a conductive polymer and then compositing the surface-treated silicon-based powder with graphene or reduced graphene oxide or by simultaneously compositing the surface-treated silicon-based powder with the conductive polymer and the graphene or the reduced graphene oxide; and
a composite powder manufacturing step of manufacturing a silicon-based composite anode material by washing, filtering, and drying the silicon-based composite solution.

2. The method of claim 1, wherein the surface treatment step includes a surface modification process for forming a hydroxy radical on a surface of the silicon-based powder.

3. The method of claim 1, wherein the silicon-based powder includes one or more selected from the group consisting of pure Si, SiOx (0.5≤x≤1.5), Sic, and a Si alloy having an average diameter of 1 nm to 100 μm.

4. The method of claim 1, wherein the conductive polymer includes one or more selected from the group consisting of polypyrrole, polythiophene, polyacetylene, polyaniline, poly(3,4-ethylenedioxythiophene) (PEDOT:PSS), poly(p-phenylene), and poly(p-phenylene vinylene).

5. The method of claim 1, wherein the graphene is graphene or reduced graphene oxide having 1 to 6 layers and an average diameter of 1 to 10 μm.

6. The method of claim 1, wherein in the composite solution preparation, the conductive polymer is added to the surface-treated silicon-based powder solution in distilled water, and then stirred to react to prepare a silicon-based powder-conductive polymer composite solution, and
the graphene or the reduced graphene oxide is then mixed with the silicon-based powder-conductive polymer composite solution and reacted.

7. The method of claim 1, wherein in the composite solution preparation, the conductive polymer and the graphene or the reduced graphene oxide are simultaneously added to the surface-treated silicon-based powder solution in distilled water, stirred, and reacted.

8. The method of claim 1, wherein in the filtering, washing, and drying, a structure stably surrounding a surface of the silicon-based powder is formed by filtering the silicon-based powder-conductive polymer-graphene composite solution to remove a solvent, washing the silicon-based composite powder with purified distilled water to remove impurities, excess ions, and oligomers adsorbed on the surface of the silicon-based composite powder, and removing residual moisture through a drying process to coat the surface of the silicon-based powder with the conductive polymer and the graphene or the reduced graphene oxide.

9. The method of claim 1, wherein the silicon-based composite powder includes a silicon-based powder located at an inner center, graphene or reduced graphene oxide coated to surround an outer side of the silicon-based powder, and a conductive polymer disposed in a space between the silicon-based powder and the graphene or the reduced graphene oxide and coated to surround the silicon-based powder.

10. The method of claim 1, wherein the silicon-based composite powder includes a silicon-based powder located at an inner center, and a mixed composite coated to surround an outer side of the silicon-based powder, wherein the mixed composite includes a conductive polymer and graphene, and the graphene is graphene or reduced graphene oxide having 1 to 6 layers and an average diameter of 1 to 10 μm.

11. A high-performance silicon-based composite anode material coated with a conductive polymer and graphene or reduced graphene oxide manufactured by the method of claim 1, wherein the silicon-based composite anode material comprises:
a silicon-based powder located in an inner center;
graphene or reduced graphene oxide coated to surround an outer side of the silicon-based powder; and
a conductive polymer disposed in a space between the silicon-based powder and the graphene or the reduced graphene oxide and coated to surround the silicon-based powder.

12. A high-performance silicon-based composite anode material coated with a conductive polymer and graphene or reduced graphene oxide manufactured by the method of claim 1, wherein the silicon-based composite anode material comprises:
a silicon-based powder located in an inner center; and
a mixed composite coated to surround an outer side of the silicon-based powder,
wherein the mixed composite includes a conductive polymer and graphene, and
the graphene is graphene or reduced graphene oxide having 1 to 6 layers and an average diameter of 1 to 10 μm.
